(19) United States
(12) Patent Application Publication
(10) Pub. No.: US 2008/0216142 A1
(43) Pub. Date: Sep. 4, 2008

(54) System and method of digital media distribution

(76) Inventors: Brett M. Goldberg, Seattle, WA (US); Bradley C. Merrill, Redmond, WA (US); Stanley Ng, Lynnwood, WA (US)

Correspondence Address: PERKINS COIE LLP;PATENT-SEA, P.O. BOX 1247, SEATTLE, WA, 98111-1247, US

(21) Appl. No.: 11/506,464

(22) Filed: Aug. 17, 2006

(51) Int. Cl. H04N 7/173

(52) U.S. Cl. 725/115

(57) ABSTRACT

A system and method for the managed distribution of digital media. A capture station captures media resources by converting the media resources into digital form. Once captured in digital form, the digital media is communicated to a formatting server. The formatting server encodes and encrypts the digital media into a desired form for distribution by the system. The digital media is stored in a master media server. Users are allowed to access the digital media using a media presentation client. A user can request access to digital media stored on the master media server. The system allows various access restrictions to be defined to restrict access to the digital media. If a user is authorized to access a piece of digital media, the digital media may be delivered to the media presentation client by the master media server.

### FIELD OF THE INVENTION

This invention relates generally to digital media, and more specifically, to system and method for digital media distribution.

### BACKGROUND

Ever since media took on digital form, the issue of legally presenting, organizing and disseminating digital media has been an issue. Initially, songs were the main form of digital media that was shared and copied over the Internet, but as speeds of data transfer began to increase, movies began to become increasingly shared over the Internet. Although many individuals choose to break copyright and other laws by copying and sharing protected digital media, individuals and institutions who wish to respect copyright and other laws need an efficient system of legally presenting, organizing and disseminating digital media.

Dealing with copyright protected digital media can be unwieldy and difficult, especially for larger entities that may need to keep track of large volumes of media and a large number of users of the media. Typically, large entities such as schools, universities and companies require users of their digital media resources to visit a location such as a library or media center in order to access the digital media resources. In many cases a user must check-out a physical copy of the digital media he or she wants to use (e.g., CDs, DVDs, videotapes, etc.) and view and/or listen to it on the premises. In other cases the user may check-out the media for a limited time, take it off the premises, and return it shortly thereafter.

Traditional distribution methods for digital media present many problems for users of the media. First, users can only check-out and view the media they need during the hours that the library or media center is open; furthermore, the time that users can view media is typically a short time period and may not be convenient for the user's needs. In the modern age of internet and global communication technology, people have become accustomed to having media on demand and being able to access it from their computer, cellular telephone, or personal data assistant. Additionally, many students and business people prefer to work at odd hours, such as late at night or early in the morning, when libraries and media centers and typically not open. Moreover, many business people and students work remotely and cannot visit a physical library or media center, even during business hours. Therefore, what are needed are improved systems and methods for digital media distribution.

### BRIEF DESCRIPTION OF THE DRAWINGS

FIG. 1 is a block diagram of a system for digital media distribution.

FIG. 2 is a representative screenshot of a user interface to allow metadata to be stored about a piece of digital media.

FIGS. 3A and 3B are communication flow diagrams indicating messaging between a media presentation client, master media server, and secondary media server when access to a piece of digital media is requested.

FIG. 4 is a block diagram of a system for digital media distribution as implemented for educational institutions.

FIG. 5 is a block diagram of a method of grouping users and providing selective access to digital media.

FIG. 6 is a representative screenshot of a user interface to allow pieces of digital media to be associated with educational courses.

FIG. 7 is a representative screenshot of a user interface to allow pieces of digital media to be managed by a system operator.

FIG. 8 is a flow chart of a process for digital media distribution.

### DETAILED DESCRIPTION

A system and method are disclosed for the managed distribution of digital media. The distribution system includes one or more capture stations, formatting servers, and master media servers. The capture station captures media resources by converting the media resources into digital form (if not in digital form) or copying the media resources (if already in digital form). Once captured in digital form, the digital media is communicated to a formatting server. The formatting server encodes and encrypts the digital media into a desired form for distribution by the system. After encoding and encrypting at the formatting server, the digital media is communicated to a master media server that can store and communicate digital media. A media presentation client is provided to allow users to utilize the digital media. A user can request access to digital media stored on the master media server. The system allows various access restrictions to be defined to restrict access to the digital media. If a user is authorized to access a piece of digital media, the piece of digital media may be delivered to the media presentation client by the master media server.

In some embodiments, the system includes one or more secondary media servers that are in communication with the master media servers. A secondary media server can receive and store one or more pieces of digital media from a master media server. Utilizing a media presentation client, users can request access to digital media stored on the secondary media server. If the secondary media server contains the requested piece of digital media and the user is authorized to access the piece of digital media, the piece of digital media may be delivered to the media presentation client by the master media server. If the secondary media server does not contain the requested piece of digital media, the piece of digital media may be delivered from the master media server.

In some embodiments, the system distributes digital media to secondary media servers depending on the access requests that are made or are expected to be made by the media presentation clients that utilize the secondary media servers. Digital media may be distributed based on anticipated need, and may be removed from the secondary media servers when no present need is anticipated. Managing the amount and identify of digital media on secondary media servers in this fashion optimizes the use of system resources and heightens the security of the system.

In some embodiments, certain pieces of digital media that are stored in the system may be syndicated for access by other groups of media presentation clients. Proprietary digital media that is uploaded to the system by an operator such as a university or a library may be made available to other users of the system in a controlled fashion. When syndicated, various rights may be defined to allow authenticated users to view, manipulate, redistribute, etc. the syndicated digital media. The system thereby allows the lawful sharing of digital media in a controlled fashion.

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

As described herein, a first element is defined as being in communication with a second element when information of any form can be transferred from the first element to the second element, when information of any form can be transferred from the second element to the first element or when information of any form can be transferred from the second element to the first element and when information of any form can be transferred from the first element to the second element. As described herein, information can be transferred between elements that are in communication by any means known or unknown, which includes, but is not limited to a telephone network, a wireless network, a wi-fi or wide fidelity network, a satellite network, a local area network, the Internet, FTP, light, radio, or methods of physical transfer such as the mails.

As described herein, “system operator” or “operator” refers to an entity that is allowed access to certain management or other functionality of the system. System operators may have different levels of access permission, and may be associated with different entities. For example, at the highest level an entity may have ownership and control over a distribution system, which allows the entity to add, modify, or remove functionality offered by the system. At a lower level, certain entities that use the services of the distribution system may be allowed to add, delete, or manage digital media that is stored in the system, but not to perform other functions. At yet another level, certain entities may only be provided access to functionality that allows them to capture digital media data and define metadata for the system. Each of these entities may be considered a system operator for the functionality that they are granted access to.

As described herein, “media” refers to any means of conveying or communication visual, auditory, tactile, or olfactory information. Media includes, but is not limited to, newspapers, magazines, books, motion pictures, radio, television, the world wide web, compact discs (CD), digital versatile disc (DVD), digital video disc (DVD), tapes, records, VHS tapes, Video CD, Mini-DVCAM, S-VHS, Mini-DV, betamax, betacam, D-VHS, DV, Lazerdisc, DVCAM, Betacam SP, Betacam SX, MPEG/IMX, Digi-beta, reel-to-reel tapes, 8 millimeter tape, Super-8 tape, Hi-8 tape, Digital-8 tape, C-VHS, D-9, HDCAM, DVCPRO, videodiscs, data files or information, microfilm, slides, photographs, videocassettes, and other forms of publishing. Additionally, media may embody one or more form of communication, including but not limited to a song, album, movie, motion picture, article, weblog, story, speech, picture, pantomime, choreography, play, game or poem.

### I. Digital Media Distribution System

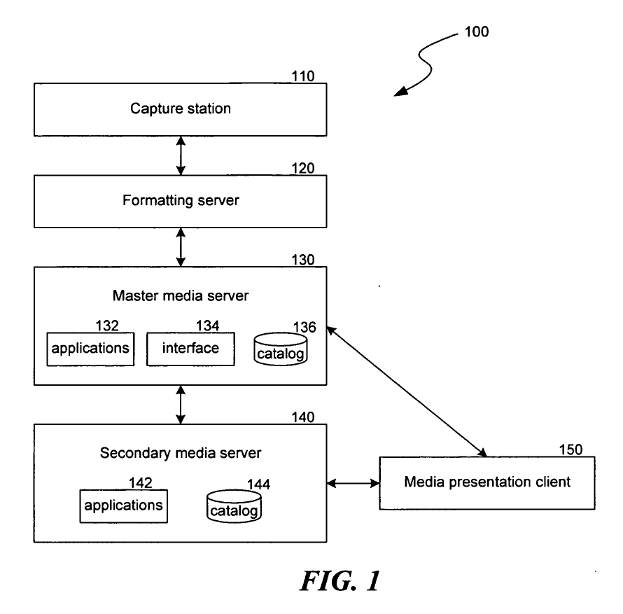

FIG. 1 is a block diagram of a system 100 for digital media distribution. The system 100 is comprised of a capture station 110 for capturing digital media data, a formatting server 120 for converting digital media into a proper format for distribution, and a master media server 130 and secondary media server 140, for distributing the digital media to end users. The end users are able to access the digital media using a media presentation client 150. As depicted in FIG. 1, the capture station, formatting server, master media server, and secondary media server are in communication with each other to allow pieces of digital media to be transferred between each of these components. The media presentation client is able to access the digital media by communicating with the master or secondary media servers. The operation of each of these components will be addressed in turn below.

The capture station 110 allows a system operator to receive, copy, or convert one or more pieces of media to digital form, or if already in digital form to another digital form. Each piece of media may be in one or more format of media, and may comprise one or more works of audio, video or other information. Capture station 110 may be a multi-purpose device such as a computer, or a dedicated device such as a DVD recorder or VHS recorder. For example, a system operator can insert, couple, or otherwise relate a DVD with the capture station 110 such that the capture station 110 can read the media contained on the DVD. The system operator can then convert the media read from the DVD into MPEG (Moving Picture Experts Group) format or other digital format and then store or communicate the media in the converted digital form. The digital media may be stored in memory, stored in mass storage devices, burned onto a DVD or a CD, or otherwise retained for future use in some fashion.

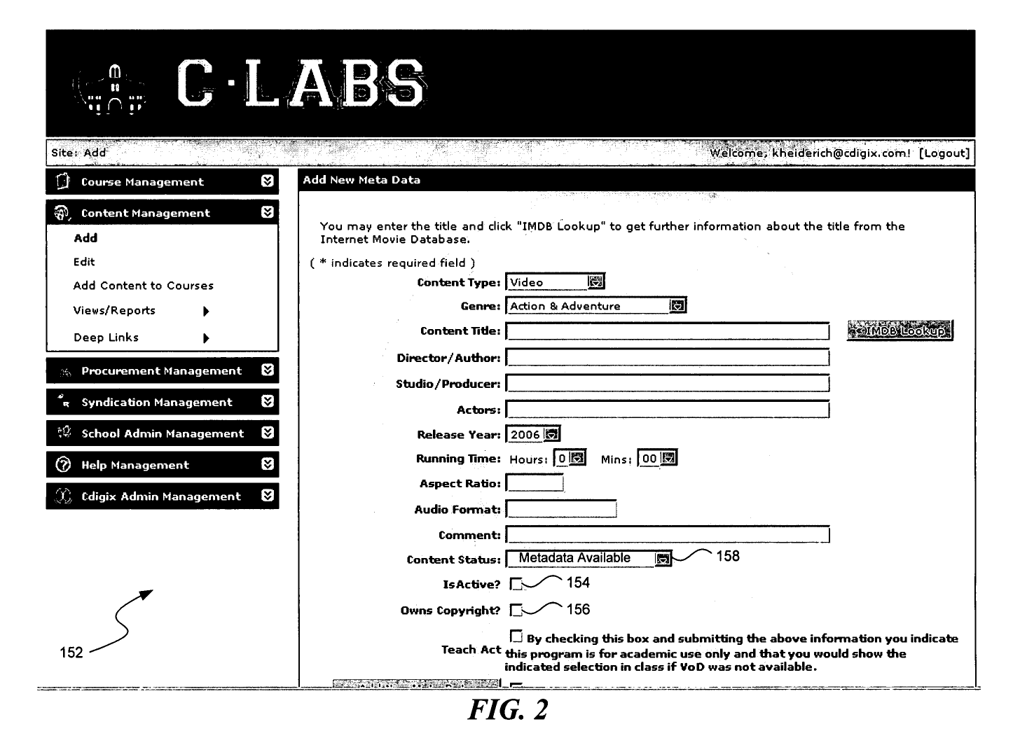

At the time of capture, various metadata may be stored in associated with the piece of digital media. FIG. 2 is a representative screenshot of a user interface 152 to allow an operator of the capture device to store various pieces of information about the digital media. Such metadata can include, but is not limited to, digital media type, genre, title, author, director, studio, producer, actors, performers, release year, running time, aspect ratio, audio format, comment, and status. The information may be automatically completed by the capture server via access to external databases, or may be entered by the operator of the capture device. In particular, two pieces of metadata are utilized by the system to control subsequent access and use of the digital media. An “IsActive” checkbox 154 is provided to allow the operator to indicate whether the digital media should be made immediately accessible to users. An “Owns Copyright” checkbox 156 is provided to allow the operator to indicate that the party submitting the media for addition to the system owns or controls the copyright to the work. A “Content Status” pull-down menu 158 is provided to allow the system operator to track where a particular piece of media is in the conversion process (e.g., awaiting formatting, awaiting uploading, etc.). Functionality that relies on these pieces of metadata will be described in additional detail herein.

The capture station 110 is in communication with the formatting server 120 so that captured digital media can be transferred from the capture station 110 to the formatting server 120. For example, the capture station 110 may be in communication with the formatting server 120 via mail (e.g., by burning digital media onto a DVD or CD and sending the DVD or CD to the formatting server 120 via any method of shipping such as Federal Express), via the physical transfer of media (e.g., by carrying a DVD from the capture station to the formatting server), or via the Internet or other private or public network (e.g., using a file transfer protocol). It will be appreciated that the capture station 110 and formatting server 120 can be in the same, similar, or disparate physical locations. Moreover, the capture server and the formatting server may be operated by the same or different parties.

Once digital media has been captured by the capture station 110 and communicated to the formatting server 120, the digital media can be encoded and encrypted by the formatting server 120. The formatting server coverts the digital media received in one format into a format that is more readily distributed by the system to the media presentation clients 150. For example, the formatting server 120 may receive the digital media in Moving Picture Experts Group (MPEG) format and convert, break-up, or copy the digital media in MPEG format to Windows Media Video or Windows Media Variable-Bitrate (WMV) format (Microsoft, www.microsoft.com), RealMedia Variable-Bitrate format (RMVB) (Real Networks, www.real.com), Apple QuickTime format (Apple Computer, www.apple.com), or any other encoding format. Such encoding is well known in the art and one reasonable skilled in the art will immediately recognize that such conversion can be achieved in many ways. Moreover, the encoding process may be fully automated (e.g., when a piece digital media is received via a network connection), or semi-automated (e.g., involving one or more manual steps by the system operator). In one embodiment, the formatting server 120 encodes digital media into a form or format that is 750×450 pixels, Red-Green-Blue (RGB) 24, and 30 frames-per-second.

While only a single formatting server 120 is depicted in FIG. 1, those skilled in the art will appreciate that the formatting server may be comprised of a plurality of servers located in the same, similar, or disparate locations. In certain circumstances the formatting server 120 is not required to encode received digital media. For example, the digital media may be received from the capture station in a format that is suitable for distribution to the media presentation clients 150. In such an event, no further encoding needs to be performed by the formatting server 120.

Once the formatting server 120 encodes the digital media, the digital media may then be encrypted. The digital media can be encrypted using a variety of different technologies, including, but not limited to, WMV Encrypt or Windows Media Rights Manager (WMRM) (Microsoft, www.microsoft.com) and Real Media Secure via Real Packager (Real Networks, www.real.com). The encryption strength may be 40-bit, 128-bit, 1024-bit or any other level as warranted by the particular digital media and media presentation client. Those skilled in the art will appreciate that trade-offs may be made between encryption strength, ease of use, and desired level of security. In some embodiments, the formatting server does not encrypt digital media. Encryption of digital media may be omitted, for example, when the digital media is in the public domain or is released under certain licenses granting significant rights of use.

Once digital media is in the proper format for distribution to the media presentation clients 150, the digital media can be communicated to the master media server 130. The master media server 130 is any system that can be configured to receive, store, and distribute digital media. In some embodiments, the master media server 130 is a server or a computer. The master media server contains application software 132 that implements many of the processes and functions described herein, and interface software 134 to generate a user interface (such as a web interface) that allows system operators to manage the system. The application software may include administrative tools, monitoring tools, reporting tools, and other utilities that are known to those skilled in the art. The master media server 130 also contains a catalog 136 of all of the digital media that is accessible through the system. The catalog contains copies of the digital media or an indication of where the digital media is stored if the digital media is not stored locally to the master media server. Those skilled in the art will appreciate that while a single server is shown, the master media server can be comprised of a plurality of servers that are located in the same, similar, or disparate locations. The application software 132 may be implemented on the master media server, or on a dedicated server separate and apart from the server than maintains the catalog 136. The digital media may be stored at the same location as the master media server, or may be stored in a distributed fashion, such as edge-cached by a third-party service on a network.

The master media server 130 is further in communication with the secondary media server 140. As with the master media server, the secondary media server 140 is any system that can be configured to receive, store, and distribute digital media. The secondary media server contains application software 142 that implements many of the processes and functions described herein. Those skilled in the art will appreciate that while a single server is shown, the secondary media server 140 can be comprised of a plurality of servers that are located in the same, similar, or disparate locations. As will be described in additional detail below, the secondary media server 140 includes a catalog 144 containing copies of or pointers to a subset of the digital media that is available at the master media server 130. Depending on access patterns to the digital media stored in the system, certain portions of the digital media catalog contained in the master media server will be replicated to a catalog that is maintained by the secondary media server. For example, pieces of digital media may be transferred to the secondary media server as they are requested by users that are proximate to the secondary media server. Alternatively, pieces of digital media or portions of the digital media catalog may be transferred to the secondary media server if it is anticipated that the pieces or portions will be frequently accessed by users that typically access the secondary media server. The secondary media server 140 is typically located closer to the media presentation clients 150 that access the system than the master media sever 130. For example, the secondary media server may be located in the same room, building, block, town, city, or country as the media presentation clients that access the server.

The media presentation client 150 is any system that is capable of presenting digital media, including, but not limited to, a computer, a laptop computer, a personal data assistant, a cellular telephone, a portable music device, a game console, a television, a printer, or a projector. The media presentation client 150 is capable of communicating with the master media server 130 and the secondary media server 140. The media presentation client 150 can receive and present digital media that is stored on one or both of the master media server 130 or the secondary media server 140.

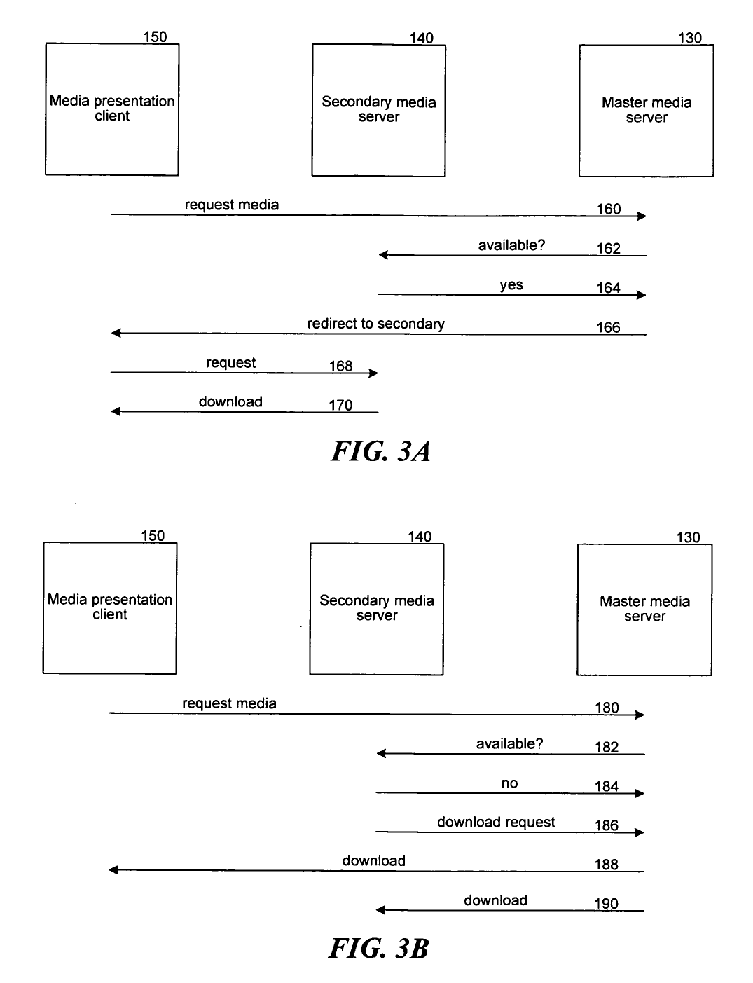

In some embodiments, the media presentation client 150 will prioritize downloading digital media from the secondary media server 140 over downloading digital media from the master media server 130 and will only download a requested item or piece of digital media from the master media server 130 if it is not available or stored on the secondary media server 140. Since the secondary media server 140 and the media presentation client 150 may be in relatively close physical proximity to each other, it is preferable to first attempt access over the shorter communication path as compared to the communication path with the master media server (the master media server 130 is often at a distance from the media presentation client 150, for example located in a different county, state, territory, country or continent). FIGS. 3A and 3B are diagrams of a communication flow between the media presentation client 150, the master media server 130, and the secondary media server 140 representing the messaging that occurs to download a desired piece of digital media that may be located on the master media server or the secondary media server.

FIG. 3A depicts the situation when a desired piece of digital media is stored in the secondary media server 140. As will be discussed in additional detail below, prior to the communication flow in FIG. 3A, a system user has selected a piece of digital media in which the user desires access. A first message 160 is sent from the media presentation client 150 to the master media server 130, requesting access to the piece of digital media. If the media presentation client has a right to access the piece of digital media, a second message 162 is sent from the master media server 130 to the secondary media server 140 to determine whether the piece of digital media is available from the secondary media server. In this example, the piece of digital media is available from the secondary media server, so a third message 164 is sent from the secondary media server indicating that the piece of digital media is available from the secondary media server. In a fourth message 166, the master server redirects the media presentation client 150 to the secondary media server 140. In a fifth message 168, the media presentation client 150 makes a direct request to the secondary media server 140 for the piece of digital media. In a sixth message 170, the secondary media server 140 responds by initiating delivery of the piece of digital media. In some embodiments, the delivery results in the download of the piece of digital media to the media presentation client 150. Downloading the digital media results in a better user experience, as the display or other use of the digital media will not be impacted by network congestion or other computer problems. A user is also able to display or otherwise use the digital media as many times as are allowed by any rights control management associated with the digital media. Alternatively, the piece of digital media may be streamed or otherwise delivered to the media presentation client 150.

FIG. 3B depicts the situation when a desired piece of digital media is stored in the master media server 130. As will be discussed in additional detail below, prior to the communication flow in FIG. 3B, a system user has selected a piece of digital media in which the user desires access. A first message 180 is sent from the media presentation client 150 to the master media server 130, requesting access to the piece of digital media. If the media presentation client has a right to access the piece of digital media, a second message 182 is sent from the master media server 130 to the secondary media server 140 to determine whether the piece of digital media is available from the secondary media server. In this example, the piece of digital media is not available from the secondary media server, so a third message 184 is sent from the secondary media server indicating that the requested digital media is not available from the secondary media server. In a fourth message 186, the secondary media server 140 also makes a request to the master media server for a copy of the piece of digital media. In a fifth message 188, the master media server 130 responds by initiating delivery of the piece of digital media to the media presentation client 150. As discussed above, the delivery of the piece of digital media to the media presentation client 150 may be via download, streaming, or other technology. In a sixth message 190, the master media server 130 responds by also initiating delivery of the piece of digital media to the secondary media server 140. The delivery to the secondary media server 140 ensures that the next request from a media presentation client 150 may be serviced by the secondary media server. In other embodiments of the system, the download represented by the sixth message doesn't occur until the number of requests that are made for the same piece of digital media to the master media server exceeds a threshold. For example, the system may not download a piece of digital media to the secondary media server until the second request for the piece of digital media is received from users.

Those skilled in the art will appreciated that various changes could be made to the communication flows in FIGS. 3A and 3B without impacting the operation of the system. For example, instead of communicating with the master media server 130, the media presentation client 150 could communicate first with the secondary media server 140 to see if a piece of digital media is available locally. If not available locally, the request could be automatically communicated to the master media server for fulfillment. Certain messages may also be combined and/or omitted as part of the communication flow.

Once a piece of digital media is downloaded to the media presentation client 150, a user is allowed to utilize the digital media in a fashion that is allowed by the particular media presentation client, particular digital media player on the media presentation client, and particular digital rights management associated with the downloaded piece of digital media. In some cases, the use of the digital media may be tightly controlled so that the digital media may only be viewed and/or utilized once. In other cases, the use of the digital media may be loosely controlled so that the user is allowed to manipulate, copy, transfer to other media, or otherwise exploit the digital media. In some embodiments of the system, the system is able to monitor whether a particular piece of digital media has been played by a user.

By virtue of the described operation of the system 100, it will be appreciated that media in any form may be captured by the system, formatted for use, stored for subsequent access, and efficiently distributed to media presentation clients upon request. As will be shown in the examples that follow, such a system provides a high degree of flexibility and configurability when attempting to distribute digital media to a population of users.

### II. Digital Media Distribution in an Educational Environment; Access Control

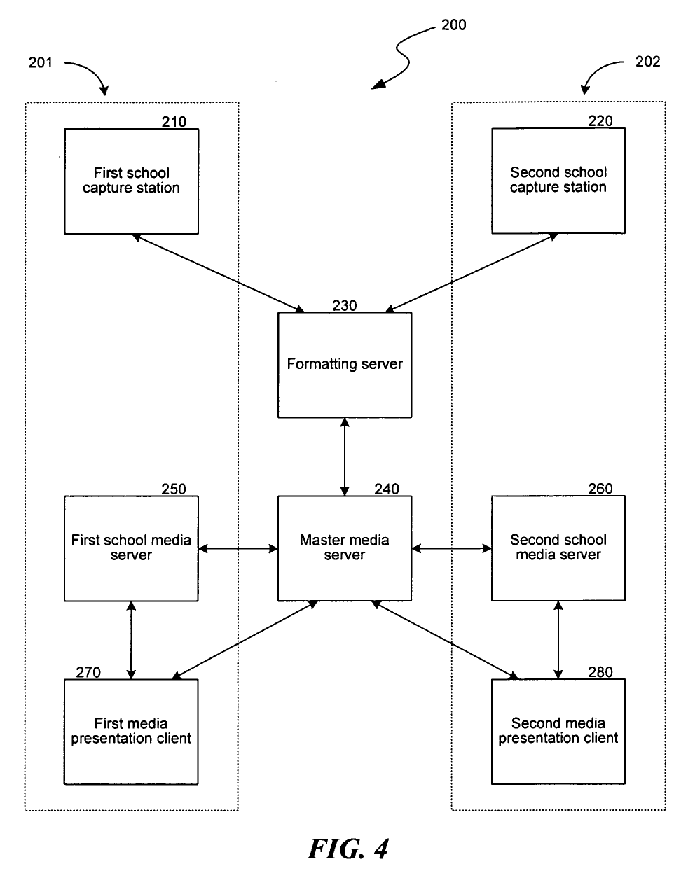

FIG. 4 is a block diagram of a system 200 for digital media distribution as utilized by a university or other educational institution. Specifically, two schools, a first school 201 and a second school 202, are depicted utilizing the system 200 to distribute digital media. The first school operates a first school capture station 210 and a first school media server 250, and offers access to users using a first media presentation client 270. The second school operates a second school capture station 220 and a second school media server 260, and offers access to users using a second media presentation client 280. The system components at both schools are in communication with formatting servers 230 and a master media server 240 that are operated by a third party. As will be described herein, one of the significant uses for system 200 at a university or other educational institution is to allow students to view videos associated with courses in which they are enrolled. Other contemplated uses for the system include sharing of student-created music or videos, distribution of digital media entertainment, and other similar applications.

Those skilled in the art will appreciate that although two schools are depicted in FIG. 4, any number of schools could interact with the system in a similar manner. Moreover, use of the system is not limited to schools, as any entity, individual or group of individuals can use the disclosed system for digital media distribution or other purposes. For example, a religious group, business organization, social organization, city, state, country, hotel, law firm or living community can use the system for distribution of digital media or other purposes. It will also be appreciated that while many of the components are identified in FIG. 4 as a single server, the components may be implemented as groups of servers or remote services. Moreover, the functionality may be distributed differently between the various entities using the system. For example, one school may operate their own capture station, whereas another school may opt to contract with a third-party to operate the capture station. As another example, the formatting may be performed at the schools, rather than by another party. Other distributions of functionality within the system are, of course, possible.

Each of the system 200 components depicted in FIG. 4 operates similarly to those system 100 components previously discussed with respect to FIG. 1. That is, the capture stations 210 and 220 are used to capture and convert media into a digital format. The formatting server 230 formats and encodes digital media that is received from the capture stations. When digital media is communicated from either of the capture stations 210 or 220 it is either tagged, grouped, organized or filed such that the digital media is associated with the school from which it was submitted. That is, digital media communicated from the first school capture station 210 is indicated as having originated from the first school 201 and the digital media communicated from the second school capture station 220 is indicated as having originated from the second school 202. The association of a piece of digital media with the school from which it is received is persistent, so that the origin of any piece of digital media may be tracked by the system. The master media server 240 maintains a catalog of master versions (or pointers to master versions) of all digital media in the system. The first and second media servers 250 and 260 operate in a similar fashion to the secondary media server 140 to maintain a local catalog and allow users to access the digital media at a server that may be proximate to their location. In a similar fashion to that depicted in FIG. 2, requests to receive digital media may be fulfilled by the school media servers 250 and 260 before being fulfilled by the master media server 240. End users such as students, faculty, and staff, are allowed to access the digital media using presentation clients 270 and 280, which operate in a similar fashion to the media presentation client 150. The school media servers may be incrementally populated with digital media from the master media server as requests are received from users to access digital media and/or may be pre-populated based on the anticipated need. For example, digital media associated with particular courses may be transferred to the school media servers prior to the start date of the courses. It will be appreciated that each school 201 and 202 may offer access through a variety of different presentation clients and therefore the digital media stored in each school media server may be maintained in a number of different formats. Users are allowed to access and utilize digital media on their own device and at a time and pace that best suits their needs.

Various levels of access control may be enabled by the system to allow the distribution of digital media to be closely managed. In a first level of access control, access to digital media is associated with the entity that submitted the digital media for capture. In the educational application depicted in FIG. 4, the first level of access control ensures that the digital media is not shared between schools without the prior express authorization to do so. Users requesting to access digital media via the school media servers 250 and 260 and master media server 240 are only allowed to access digital media that was added to the system by the school that the requesting user is affiliated with. Users cannot request or access media that has been captured by a different school; in many cases, the existence of media captured by a different school is not even viewable by the requesting user.

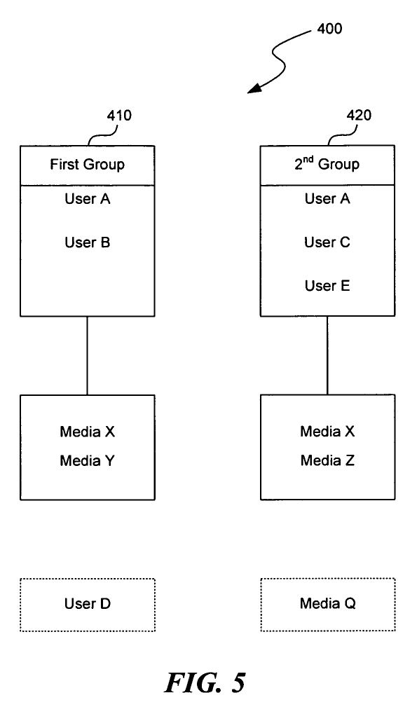

In a second level of access control, users associated with a presentation client 270 and 280 are not allowed to access a piece of digital media unless they are authorized to do so by a system operator. The second level of access control is implemented by the system 200 by allowing groups of users to be associated with pieces of digital media. Users that are members of a group are allowed access to the pieces of digital media associated with that group. Users that are not members of the group are not allowed access to the pieces of digital media associated with that group (unless they happen to have access to the particular pieces of digital media via other groups of which they are members). FIG. 5 is a block diagram depicting two groups of users for purposes of explaining the second level of access control in greater detail.

FIG. 5 depicts a first group 410, which comprises User A and User B, and a second group 420, which comprises Users A, B, and E. Two pieces of digital media, Media X and Y, are associated with the first group 410, and two pieces of digital media, Media X and Z, are associated with the second group 420. Finally, there is User D and piece of digital media, Media Q, that is not associated with any group or associated with each other.

Being a member of the first group 410 or the second group 420 allows a user to view, download, or otherwise have access or knowledge of any media associated with that group. For example, because User A is associated with both the first and second groups, User A can view, download, or otherwise have access to or knowledge of Media X, Y, and Z. User A can not, however, view, download, or otherwise have access to or knowledge of Media Q, because Media Q is not associated with either the first group or the second group. As another example, User C is member of the second group 420 and is not a member of the first group 410. Therefore, User C can view, download, or otherwise have access to or knowledge of Media X and Z. User C can not view, download, or otherwise have access to or knowledge of Media Y because User C is not a member of the second group 420, and User C will not have access to Media Q because Media Q is not associated with the second group. As yet another example, User D is not associated with either the first or second group 410, 420. User D is therefore not allowed to view, download, or otherwise have access to or knowledge of Media X, Y, Z and Q.

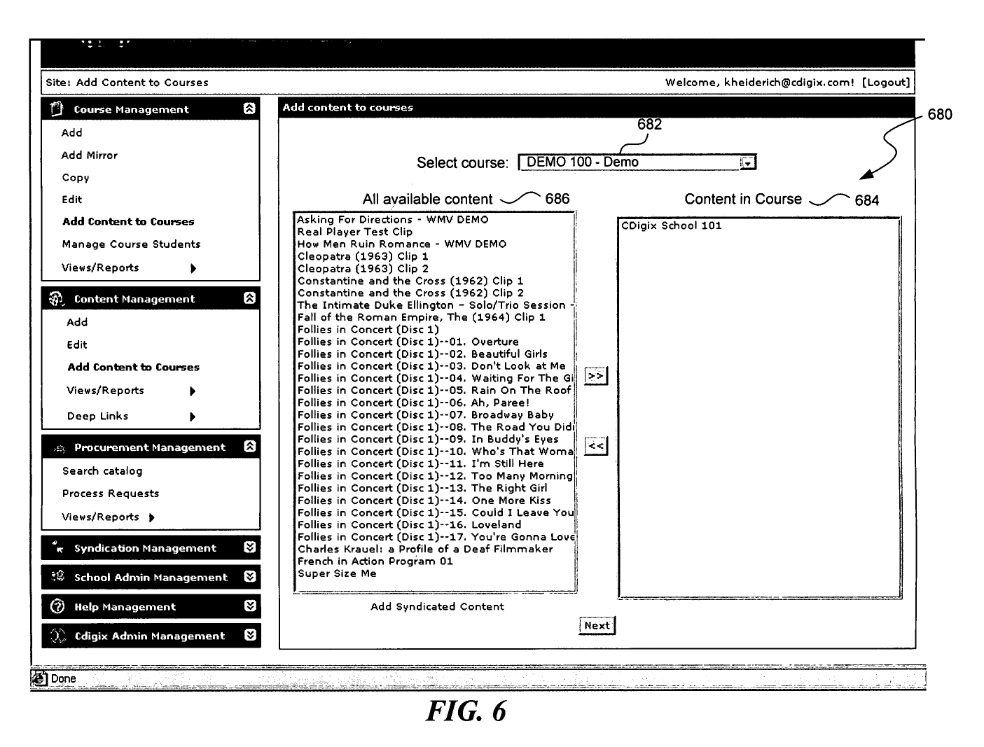

In the educational environment depicted in FIG. 4, it will be appreciated that the second level of access control may be used to associate particular pieces of digital media with courses offered by the school. That is, a group can represent a course within a school, a user can be a student or teacher enrolled in or otherwise associated the course, and digital media associated with the group can be media that is associated with the course. FIG. 6 is a representative screenshot of a user interface 680 that allows a system operator to associate particular pieces of digital media with courses in a course catalog. As shown in FIG. 6, the operator is allowed to select a course 682 from a course catalog offered by the particular school. Once the course is selected, the operator may select one or more pieces of digital media 684 that are to be associated with the course from a master list 686 of all available digital media for that particular school. The operator may define a time period (not shown) for which the digital media is to be made available. The time period may be defined at the course level, that is, all digital media associated with a particular course may not be accessible prior to the course start date or after the course end date. Alternatively, the time period may be defined for each piece of digital media, that is, a particular piece of digital media may not be accessible prior to a viewing start date and after a viewing end date. In this fashion, professors, instructors, or administrators may opt to have digital media available for review within a short timeframe to encourage access to the material, or may make the digital media available for the length of the course. When the time period has elapsed, the digital media remains on the system (i.e., stored in the master or secondary media server) but is no longer accessible to the users associated with the course.

Those skilled in the art will appreciate that the access control described herein relies upon being able to identify the user seeking access to a piece of digital media and authenticate that the user should be allowed access to the piece of digital media. In some embodiments, the system relies upon a user name and password to identify a user. In some embodiments, in order to identify the user the system may interface with security solutions that have already been implemented by an educational institution that is utilizing the system. For example, the digital media distribution system may be able to query the educational institution and request a verification of a student's status and of the courses that the student may have registered for, be currently attending, or otherwise be associated with. Similar information may be available from the educational institution for faculty, staff, and other administrators or parties associated with the institution. The educational institutions' security systems, such as Shibboleth, CAS, or others, provides the system with the necessary authentication and requested data to enable the system to determine the digital media to which the user should be provided access.

While an educational course was utilized as an example group in the discussion above, those skilled in the art will appreciated that a group can represent a department within a company, a user can be a worker within the department of the company, and media associated with the group can be media that is associated with the department. A group can also represent a type of media service offered by a media provider, a user can be a subscriber to a media service, and the media associated with the group can be the media that is associated or offered in a specific media service. A number of other applications that would take advantage of the access control described herein are also possible.

In some embodiments, a user associated with a group, in addition to being able view, download, or otherwise have access to or knowledge of digital media associated with the group, can view, download, subscribe or otherwise have access to or knowledge of a podcast that is comprised of the digital media associated with the group. The user can subscribe to the podcast using iTunes (Apple Inc., www.apple.com) or another media player, podcatcher, or aggregator such as Winamp (Nulsoft Inc, www.winamp.com) or PodSpider (RapidSoftware Solution Inc, www.podspider.com). The user can thereby download the media associated with, contained in, or listed on podcast, and automatically download media that becomes associated with the group or podcast. Systems and methods of podcasting are well known in the art and one reasonably skilled in the art will immediately appreciate the numerous embodiments and variations of podcasting that can be applied to or associated with the system.

### III. Digital Media Distribution System Administration

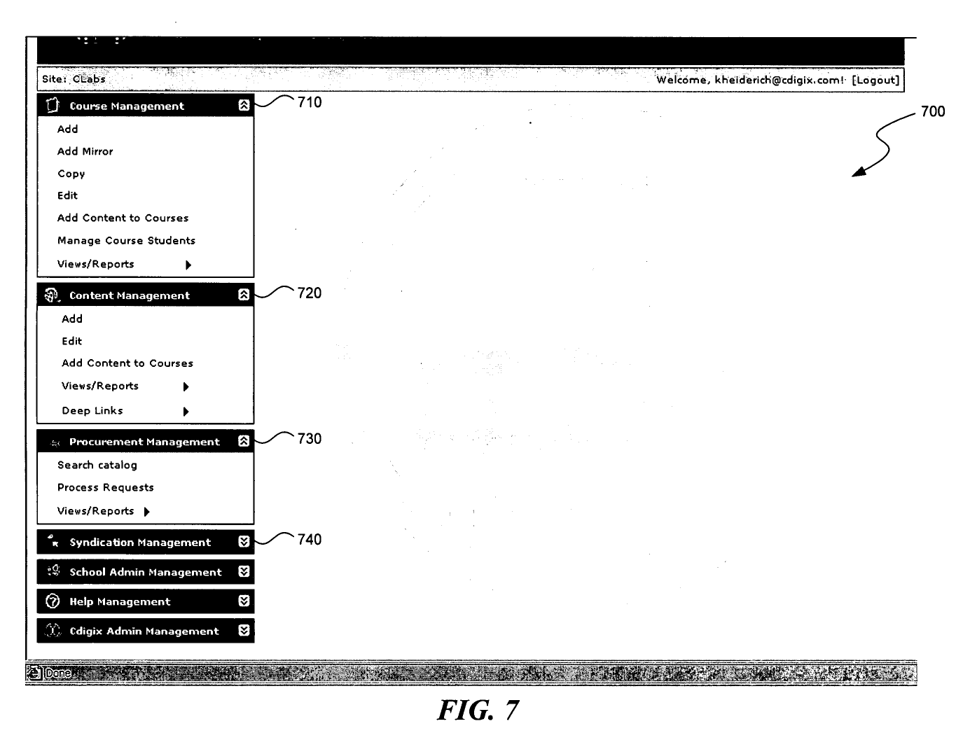

Various administrative tools may be provided by the system to enable an operator to view and manage the various digital media assets that are maintained by the system. FIG. 7 is a representative screenshot of a user interface 700 that allows an operator to manage various aspects of the digital media distribution system in an embodiment of the system that is directed to educational institutions. Some of the various features that may be managed using the interface 700 will be discussed in turn below.

As was previously described, the two levels of access control implemented by the system 200 enable the distribution of digital media to be managed on an institutional basis or group basis. To facilitate this management, the system includes a course management component 710 that allows an operator to add, delete, and modify course listings associated with a particular school. The operator is also allowed to modify the students that are associated with a particular course. The system also includes a content management component 720 to allow an operator to add digital media content to the system, edit metadata that is associated with content, and associate particular digital media with each course. The content management component also includes functionality that allows the operator to generate hyperlinks or other link that, by selecting the link, allow a student to be redirected to a course, course contents, or a particular piece of digital media. Such links can be distributed by faculty to students as part of assignments or course materials, among other uses. The operation of each of these features was previously discussed above.

In general, the system allows the members of groups and digital media associated with groups to be easily manipulated. The system allows groups of users to be created or deleted. The system also allows a plurality of media to be associated and dissociated with a plurality of groups, and a plurality of users to be associated or dissociated with a plurality of groups. The system further allows the digital media associated with a group to be easily replicated. For example, a first group can exist with a first set of users and a first set of digital media associated with the group. The system allows a second group to be created that mirrors the access rights to the first group's digital media, such that any user associated with the second group will have access to the set of media that is associated with the first group even if the set of media associated with the first group changes.

The system may also include a procurement management component 730. In some embodiments, a user can request that one or more pieces of media be procured and captured by the formatting server 230 on behalf of the user. For example, a school may request that media found on a website, catalogue, physical store, server, library, or other place or location, be captured by the formatting server. A third party may procure such media on behalf of the school and capture and format the media for the system. In some embodiments, a school may order media on Amazon.com (Amazon.com Inc, www.amazon.com) or other retailer and have the media automatically delivered to the third party for capture and formatting on behalf of the school. Media delivered in such a fashion may be tagged, grouped, organized or filed so as designate it as being associated with the school that requested the media.

The system may also include a syndication management component 740. In some embodiments, the system allows a system operator to “syndicate” digital media to other system operators of the system. With reference to FIG. 4, syndication means that first school 201 may allow one or more other schools, such as the second school 202, to access and utilize media that the first school has captured and uploaded to the system. Such media may be uniquely generated by the first school, such as a series of special lectures, classroom demonstrations, play productions, musical performances, or any other works over which the first school has control over the distribution. The syndicating system operator can identify the piece of digital media that is to be syndicated, a start date when the syndication is to begin, and an end date when the syndication is to end. The syndicating system operator may also define any rights that are associated with the syndicated content. For example, the operator may allow the syndicated piece of digital media to only be displayed in its entirety. Alternatively the operator may allow the syndicated digital media to be modified, edited, or otherwise combined with other works. Syndication is generally allowed only for those pieces of digital media that an operator has indicated are owned or controlled by the party submitting the media, such as by selecting the “Owns Copyright” checkbox 156 when entering metadata for a piece of digital media. The syndicated material may be made available for free to other entities or users, or it may be made available on a pay-per-use or subscription basis.

In some embodiments an operator can view or check the status of media that has been requested, procured, or communicated to a formatting server, master media server, or secondary media server. For example, a user can be informed that media has been procured, received, recorded, ripped, converted, encoded, encrypted, communicated or uploaded to a master media server, or communicated or uploaded to a secondary media server.

While the administrative tools discussed above and depicted in FIG. 7 are directed to educational environment, those skilled in the art will recognize that the tools may be modified for other environments in which the system may be used. The user interface 700 is therefore intended to be merely representative of the various functions and features that may be offered to a system operator.

### IV. Digital Media Processing

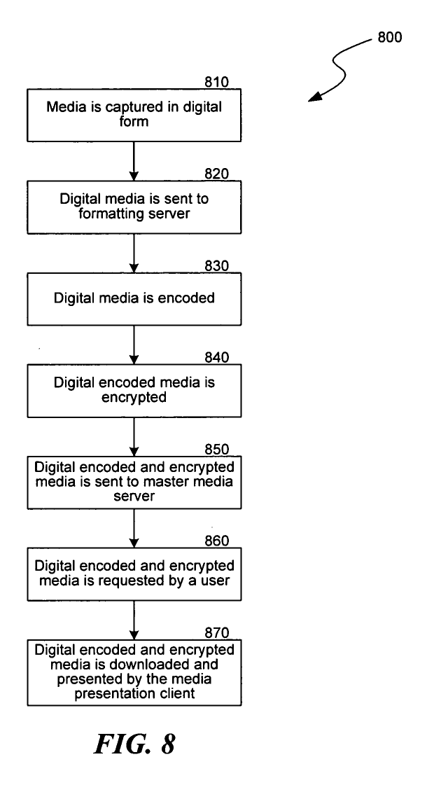

FIG. 8 is a flow chart of a process 800 of distributing digital media that is implemented by the disclosed distribution system. At a block 810, media is captured in digital form, such as in an MPEG format or other digital format. At a block 820, the digital media is sent to a formatting server. At a block 830, the digital media is encoded by the formatting server, and at a block 840, the digital media is encrypted by the formatting server. The capture, formatting, and encryption steps are optional steps, depending on the format in which the media is originally received and the intended use of the digital media by the system. Once the digital media is encrypted and in a desired format, at a block 850 the digital media is transmitted to the master media server. Once stored in the master media server, the digital media may be made available to a number of users based on a set of access rules that are defined by the system operator. At a block 860, a user requests access to a piece of digital media. At a block 870, the requested digital media is downloaded to a media presentation client and presented to the user.

While preferred and alternate embodiments of the invention have been illustrated and described, as noted above, many changes can be made without departing from the spirit and scope of the invention. Those skilled in the art will also appreciate that the system may be implemented in a variety of environments including a single, monolithic computer system, a distributed system, as well as various other combinations of computer systems or similar devices connected in various ways. Moreover, the system may utilize third-party services and data to implement all or portions of the information functionality. Those skilled in the art will further appreciate that the steps shown in FIG. 8 may be altered in a variety of ways. For example, the order of the steps may be rearranged, substeps may be performed in parallel, steps may be omitted, or other steps may be included. Accordingly, the scope of the invention is not limited by the disclosure of these preferred and alternate embodiments. Instead, the invention should be determined by reference to the claims that follow.

1. A system for distributing digital media to a plurality of users, the system comprising:
a media acquisition component that receives media in a first format and encodes the media into digital media having a second format for distribution to a plurality of users;
a master media serving component that receives digital media from the media acquisition component and stores the digital media in a master catalog that contains a plurality of digital media; and
a secondary media serving component that receives digital media from the master media serving component and stores the received digital media in a secondary catalog, wherein the secondary catalog contains a subset of the plurality of digital media in the master catalog and the digital media is periodically transferred from the master media serving component to the secondary media serving component.

2. The system of claim 1, further comprising providing a user access to the digital media.

3. The system of claim 2, wherein access to the digital media is provided to the user by the secondary media serving component if the digital media is stored in the secondary media serving component.

4. The system of claim 2, wherein access to the digital media is provided to the user by the master media serving component if the digital media is not stored in the secondary media serving component.

5. The system of claim 2, further comprising authenticating the user before providing the user access to the digital media.

6. The system of claim 2, wherein the digital media is downloaded to the user.

7. The system of claim 1, wherein the periodic transfer is a result of a request by a user to access a piece of digital media and the transfer is the requested piece of digital media.

8. The system of claim 7, wherein the piece of digital media is transferred from the master media serving component to the secondary media serving component after the number of requests from users to access the piece of digital media equals or exceeds a threshold.

9. The system of claim 8, wherein the threshold is one user.

10. The system of claim 8, wherein the threshold is two users.

11. The system of claim 1, wherein the periodic transfer is a result of an anticipated access pattern to the digital media from the secondary media serving component.

12. The system of claim 1, wherein the digital media is video media.

13. The system of claim 1, wherein the digital media is audio media.

14. A media distribution system for educational institutions that controls access to digital media by a plurality of users, the media distribution system comprising:
a master media serving component that includes a catalog of digital media, the catalog of digital media formatted for delivery to a plurality of media presentation clients;
a secondary media serving component associated with an educational institution that receives digital media from the master media serving component and stores the received digital media in a secondary catalog, the received digital media being associated with a plurality of courses being offered by the educational institution, wherein the secondary catalog contains a subset of the plurality of digital media in the master catalog and the digital media is periodically transferred from the master media serving component to the secondary media serving component;
an access management component coupled to the secondary media serving component, the access management component being operable to define a plurality of courses for the educational institution, each of the plurality of courses having one or more user members and one or more pieces of digital media from the secondary catalog that are associated with the course, the one or more pieces of digital media being transferred from the master media serving component to the secondary media serving component if the one or more pieces of media are not already present in the secondary catalog; and
an access verification component coupled to the access management component, the access management component verifying, for each request from a user to access a piece of digital media, that the user is a member of a course that is associated with the requested piece of digital media, the access verification component allowing the user to access the requested piece of digital media from the secondary media serving component using a media presentation client if the user is so verified.

15. The media distribution system of claim 14, wherein the access management component is further operable to define a start date of a course, wherein the one or more pieces of digital media associated with the course are not accessible prior to the start date.

16. The media distribution system of claim 14, wherein the access management component is further operable to define an end date of a course, wherein the one or more pieces of digital media associated with the course are not accessible after the end date.

17. The media distribution system of claim 14, wherein the access management component is further operable to define a viewing start date of a piece of digital media, wherein the piece of digital media is not accessible prior to the viewing start date.

18. The media distribution system of claim 14, wherein the access management component is further operable to define a viewing end date of a piece of digital media, wherein the piece of digital media is not accessible after the viewing end date.

19. The media distribution system of claim 14, wherein the access management component is further operable to associate a course with an educational institution.

20. The media distribution system of claim 19, wherein the access verification component further verifies that the user is a student of the educational institution that is associated with the course.

21. The media distribution system of claim 20, wherein the verification that the user is a student of the educational institution is performed by the educational institution.

22. The media distribution system of claim 14, wherein the access management component is further operable to modify the one or more user members and one or more pieces of digital media from the catalog of digital media that are associated with the course.

23. The media distribution system of claim 14, wherein the digital media is video media.

24. The media distribution system of claim 14, wherein the digital media is audio media.

25. The media distribution system of claim 14, wherein the user is allowed to download the requested piece of digital media from the media serving component.

26. A method of managing the contents of a catalog of digital media at an educational institution, the method comprising:
maintaining a list of courses associated with an educational institution, each course in the list of courses having one or more pieces of digital media that are associated with the courses, the one or more pieces of digital media being stored in a catalog of digital media managed by a media serving system associated with the educational institution;
receiving a request from an administrator to add a piece of digital media to a course in the list of courses;
determining whether the requested piece of digital media is contained in the catalog of digital media;
if the request piece of digital media is contained in the catalog of digital media, associating the requested piece of digital media with the course and allowing a student in the course to access the requested piece of digital media; and
if the requested piece of digital media is not contained in the catalog of digital media, receiving the requested piece of digital media from a remote catalog of digital media maintained by a second media serving system not associated with the educational institution and storing the received piece of digital media in the media serving system associated with the educational institution, associating the requested piece of digital media with the course, and allowing a student in the course to access the requested piece of digital media.

27. The method of claim 26, wherein the administrator is able to associate a start date with a course, and a student is not allowed to access the requested piece of digital media prior to the start date of the course.

28. The method of claim 26, wherein the administrator is able to associate an end date with a course, and a student is not allowed to access the requested piece of digital media after the end date of the course.

29. The method of claim 26, wherein the administrator is able to associate a viewing start date with a piece of digital media, and the student is not allowed to access the requested piece of digital media prior to the viewing start date.

30. The method of claim 26, wherein the administrator is able to associate a viewing end date with a piece of digital media, and the student is not allowed to access the requested piece of digital media after the viewing end date.

31. (canceled)

32. The method of claim 26, further comprising determining whether the user is associated with the educational institution prior to allowing the user to access the requested piece of digital media.

33. The method of claim 32, further comprising:
making a request to the educational institution to verify that the user is a student of the educational institution; and
receiving a response from the educational institution as to whether the user is a student of the educational institution.

34. The method of claim 38, wherein the user is determined to be associated with the course by:
making a request to the educational institution to verify that the user is associated with the course; and
receiving a response from the educational institution as to whether the user is associated with the course.

35. The method of claim 26, wherein the digital media is video media.

36. The method of claim 26, wherein the digital media is audio media.

37. The method of claim 26, further comprising transmitting the requested piece of digital media to the user.

38. The method of claim 26, further comprising determining whether the user is associated with the course prior to allowing the user to access the requested piece of digital media.
